(19) United States
(12) Patent Application Publication
(10) Pub. No.: US 2026/0015742 A1
(43) Pub. Date: Jan. 15, 2026

(54) ELECTROLYSIS SYSTEM

(71) Applicant: Siemens Energy Global GmbH & Co. KG, München (DE)

(72) Inventors: Sven Schumann, Wilhermsdorf (DE); Marvin Bendig, Zirndorf (DE)

(21) Appl. No.: 18/995,216

(22) PCT Filed: Jul. 5, 2023
(86) PCT No.: PCT/EP2023/068481

§ 371 Date: Jan. 16, 2025

(30) Foreign Application Priority Data
Jul. 21, 2022 (DE) 10 2022 207 495.5

(51) Int. Cl. C25B 9/65; C25B 9/70; H02J 3/00

(52) U.S. Cl. CPC C25B 9/65; C25B 9/70; H02J 3/00

(57) ABSTRACT

The invention relates to an electrolysis system including an electrolysis plant and a power supply source with a direct voltage output and including a central supply line, wherein the central supply line is connected to the direct voltage output of the power supply source such that a direct current can be fed to the central supply line, where a central DC high-performance strand designed for the direct voltage is provided, to which high-performance strand the electrolysis plant is connected via the central supply line, wherein at least the power supply source and the DC high-performance strand are designed as a network insulated from ground. The invention also relates to the use of an insulated DC network in an electrolysis system.

### BACKGROUND

The invention relates to an electrolysis system, comprising at least one electrolysis plant and a power supply source with a direct voltage outlet and comprising a central supply line. The invention also relates to a use.

During electrolysis, redox reactions related to material conversions may be enforced by impressing an electric current through suitable cell elements. A device for this purpose is called an electrolyzer and may be used to produce important raw materials in the chemical industry. In many cases, anode and cathode half-spaces are separated by means of diaphragms (or membranes) which allow electrical conductivity (ion and/or proton exchange) but prevent mass transfer. If electrolyzers use liquid electrolytes which are altered or consumed by the material conversion, these may be continuously renewed during the process by means of corresponding supply lines and discharge lines. The material conversion rates for given cell elements are typically subject to narrow limits due to current density constraints. For large-scale use, the active cell element surface must therefore be increased in order to increase material conversion rates. This may be achieved by enlarging the cell elements or by operating a plurality of smaller cell elements simultaneously. A technically sensible and frequently applied method is the arrangement of many (identical) cell elements into a stack. In this context, the electrical connection of the cell elements of a stack represents a series connection, i.e., the anode of a cell element N is connected to the cathode of cell element N+1, and the cathode of cell element N is connected to the anode of cell element N−1 in an electrically conducting manner. The series connection also multiplies the low cell element voltage from a few volts to, for example, several hundred volts.

On the other hand, the hydraulic interconnection of the cell elements of a stack for supplying fresh electrolytes constitutes a parallel connection. By hydraulically interconnecting the cell elements to form a stack, additional and undesirable electrically conductive connections are created between all of the cell elements. During operation of the stack of cell elements, i.e., application of an electric voltage or impressing of an electric current from the first to the last cell element, an electric working current flows through all of the cell elements: however, undesirable so-called electric stray currents additionally flow in the various parallel current paths. These electric stray currents lead, in particular at the first and last cell elements of a stack, to excessive local current density elevations close to the supply lines and discharge lines of the electrolytes. This may lead to premature ageing and destruction of the membranes and to failure of the entire stack.

DE 10 2020 206 341 A1 describes a method for protecting an electrolysis stack comprising multiple cell stacks or modules from corrosion, and a corresponding electrolysis stack. In particular, the method is for reliable protection of CO2 electrolysis from corrosion when not in operation or for transportation purposes of the electrolysis stack.

The electrolytic generation of hydrogen as a product of the electrochemical decomposition of water as a raw material on an industrial scale has attracted great economic interest and development efforts. Today, for example, hydrogen is generated from water by means of proton exchange membrane (PEM) electrolysis, an anion exchange membrane or alkaline electrolysis. The electrolysis plants produce hydrogen and oxygen from the supplied water by means of electrical energy. However, electrolysis plants based on alkaline electrolysis are also widely used.

Current considerations focus on generating recyclable materials using excessive energy from renewable energy sources at times of an abundance of sunshine and wind, i.e., of above-average solar energy or wind energy generation. In particular, a recyclable material may be hydrogen generated by corresponding water electrolysis plants. For example, based on hydrogen, what is known as renewable energy gas—also referred to as RE gas—may be produced. RE gas is a combustible gas obtained from renewable sources by means of electrical energy.

The increasing use of wind power provides a source of renewable energy. In particular, wind turbines near the coast, so-called offshore wind turbines, allow for providing large amounts of electrical power. However, managing a large distance to the consumers is challenging. Therefore, the energy should be transported to the consumer with as little loss as possible. Hydrogen is highly suitable as a transport medium and energy carrier. For example, it may be transported in gaseous form through pipelines. A positive side effect is that a hydrogen-carrying pipeline may simultaneously serve as an energy storage as the internal pressure may be varied to a certain extent.

Based on these considerations, producing the hydrogen directly at the site of energy generation, i.e., autonomously and independently from the public grid, is of particular economic interest. To this end, electrolysis plants on offshore platforms in maritime areas are proposed to be installed directly at or in close proximity to offshore wind turbines and to be electrically supplied with the wind power generated directly by a wind turbine, and to operate the electrolysis system in a so-called microgrid which is off-grid from the public grid.

Such concepts of immediately utilizing power from onshore wind turbines or even photovoltaic plants at least partly by direct coupling to and feed into an electrolysis plant for generating hydrogen have also been proposed for the mainland. In all of these autonomous applications, the electrolysis plant is part of a so-called microgrid. Thus, in such an electrolysis system, the electrolysis current is regularly not obtained from the public grid, but is rather delivered in a network directly by a wind turbine or a PV plant and fed into an electrolyzer of the electrolysis plant via a supply line. As such, the electric energy generated by a wind turbine or a PV plant may also be buffered in a battery, for example.

Contrary to the grid operation described above, microgrid operation poses particular challenges and issues of the electrolysis system regarding the electrical coupling and interconnection of the electrolysis plant to the respective RE generating plant, be it a wind turbine or a photovoltaic plant, in particular to ensure secure and especially failure-free operation of the electrolysis plant in a close network of plants with the RE generating plant.

A problem, which must be taken into account in particular, is that with an electrolysis system forming an integrated and autonomous microgrid, the hydrogen electrolysis cells—based on the modules—of the electrolysis plants connected thereto create corresponding electric stray currents against ground. These stray currents flow via the process water lines and lead to undesirable corrosive damage thereon—even with sufficient insulation distances. Here, metal ions are released into the process water, leading to irreversible damage or accelerated ageing, in particular on the PEM membranes. In applications of both PEM electrolysis and alkaline electrolysis systems, these stray currents also reduce efficiency. Therefore, the corrosive effects of stray currents are to be reduced as much as possible.

As an example, a reduction in the electrical stray currents may be achieved by increasing the electrical resistances of the supply lines and discharge lines of the electrolytes. The previous solution provides for the supply lines and discharge lines to be extended, consequently resulting in an increase in resistance with a constant cross-sectional area. However, the line extensions disadvantageously lead to increased flow resistances and increased material needs for manufacture, and corresponding additional construction costs. This is particularly problematic especially in remote locations where an electrolysis plant then needs to or is desired to be installed for microgrid operation, i.e., in situations where coupling the electrolysis system to the public power grid is not technically or economically feasible or would only be possible with considerable effort.

Hence, there is an increased need to identify inexpensive ways to remedy the corrosion issue in order to improve the uptime of an electrolysis system when designed for microgrid operation.

### SUMMARY

Therefore, an object of the invention is to suggest an electrolysis system which is designed for off-grid operation, in particular in combination with a wind turbine or with a solar plant, and which also has low susceptibility to corrosion due to stray currents.

According to the invention, the object of the invention is achieved by an electrolysis system comprising an electrolysis plant and a power supply source with a direct voltage output and comprising a central supply line, wherein the central supply line is connected to the direct voltage output of the power supply source such that a direct current can be fed to the central supply line, wherein a central DC high-performance strand designed for the direct voltage is provided, to which high-performance strand the electrolysis plant is connected via the central supply line, wherein the power supply source and the DC high-performance strand are designed as components of a network insulated from ground.

As such, the invention already relies on the realization that, in an electrolysis system with coupling and supply to and by the public alternating current grid, galvanic isolation is achieved with a transformer and the high-current electrolysis circuit is therefore already operated as an insulated network or may be grounded at a point on the modules. The current is reduced simply by the process engineering of the electrolysis plant not providing a good electric return conductor for the stray current or no ground loop being formed.

However, if electrolysis is to be operated as a microgrid, for example as an electrolysis system comprising an offshore wind turbine, or onshore in remote areas, or as a solar plant, there is no alternating voltage grid available or nearby with which a transformer could be operated for galvanic decoupling. In these installation situations of an electrolysis plant, it would be uneconomical to set up an alternating voltage link specifically for a transformer. This would lead to high additional levelized cost of electricity and operating costs. Therefore, this design and reliance on the public power grid would be disadvantageous for the operation of an electrolysis system as a microgrid.

In order to lessen the corrosion problem as efficiently as possible and, above all, reliably, for a microgrid, i.e., for off-grid operation, of an electrolysis system in addition to the connection and transmission issue, the invention proposes coupling or integration of the electrolysis plant to or with a central DC network specially set up for this purpose, which is designed to be ungrounded. As such, a so-called IT network (IT: isolé terre) is formed by the central DC high-performance strand and all the operating components connected thereto. The operating components forming the IT network of the electrolysis system, such as the power generator or generator of the power supply source, the central supply line and the electrolysis plant, are all designed to be ungrounded. The power supply source supplying the operating voltage is therefore insulated from ground, i.e., it is generally open or implemented via symmetrical and high-resistance grounding of the electrolysis system. In normal operation, there is therefore no low-resistance connection between the active parts of the IT network and ground or the protective conductor. As such, the central DC high-performance strand is part of the entire IT network, wherein the IT network also comprises the operating components of the electrolysis system connected thereto, such as the power supply source with the direct voltage output and the electrolysis plant.

The concept of the invention is therefore about designing and operating the entire supply strand from the generator, including the provided DC high-performance strand and the electrolysis plan, as an IT network in order to avoid the corrosive stray currents in the electrolysis. Advantageously, compared to grid operation, an AC intermediate circuit for galvanic decoupling may be omitted. Thus, with the proposed electrolysis system, an insulated DC high-performance strand is implemented in an electrolysis system such that microgrid operation is possible when connecting the electrolysis plant having a renewable energy plant (RE plant), such as a wind turbine or a photovoltaic plant, to the central DC supply line. By eliminating the need for galvanic decoupling in the central high-performance strand, the solution is significantly more compact, easier and more cost-efficient. In this case, the high-performance strand with all conductors is at an electrically undefined potential against ground.

The DC network formed by the insulated high-performance strand of the electrolysis system provides the specified high voltage and electrical direct current power in the central supply line and serves as a transmission and distribution network for the direct current. The transmission power required is transferred from the power supply source to the electrolysis plant via the central and ungrounded DC network, such that the electrolysis direct current is available. As such, the high voltage of the DC network is flexibly selectable and adaptable to a required direct voltage connection value. At the same time, by avoiding or reducing electric stray currents, especially by means of the process engineering of the electrolysis plant, the corrosion effects are decreased and thus maintenance and service costs are reduced. The electrolysis system of the invention further promotes an increase in uptime.

In one embodiment of the electrolysis system, it has an insulation monitor such that a minimum insulation resistance of the insulated network from ground is able to be monitored and an insulation fault is detectable.

The insulation resistance is preferably high-resistance such that a high-resistance grounding is designed for a specified minimum insulation resistance, which must not be undercut during operation. For this purpose, an insulation monitor is provided, which serves as a protective element and by which the insulation resistance is able to be monitored or displayed such that alarm signals can be given and measures can be taken.

The use of the insulated DC network makes the use of an insulation monitor as a protective element very advantageous. In the event of a simple ground fault, the electrolysis system, in particular the electrolyzers of the electrolysis plant, can continue to operate as there is no immediate danger, which increases availability.

The insulation monitor or insulation monitoring device monitors the insulation status of the IT network, for example local low-voltage grids without an operationally grounded star point. It reports when the minimum insulation resistance is undercut. For this purpose, only a current or voltage measurement against ground had been carried out in the past (symmetry deviation), but today it is required that symmetrical insulation faults can also be reliably detected, additionally requiring a test current. In the event of a fault, if the insulation fault current is exceeded, either only a warning can be issued or the relevant network feeder can be switched off.

In one embodiment, the insulation monitor is designed to be single-fault tolerant, such that a simple fault (single-pole ground fault) does not lead to a failure of the power supply or the relevant feeder in the electrolysis system. In this way, the power supply source or its feeders in the insulated IT direct voltage network are effectively protected.

A first ground fault is harmless in the IT network because the currents caused only by line capacities and insulation resistances of the electrolysis system and its equipment are small. If the spatial extent of the electrolysis system or the IT network formed thereby is small, the leakage currents in the event of a fault are so small that they are harmless as well.

In one embodiment, the insulation monitor detects ground faults, asymmetries and insufficient insulation resistances in the IT network. To do so, it measures the symmetry of the voltages of both network poles against ground. If the leakage currents of both network poles are the same, symmetry is maintained.

In use, a high-voltage direct current with a specified high voltage significantly above the usual mains voltage is provided at the terminals of the central supply line. Thus, in the IT network, the electrolyzers of the electrolysis plant connected to the central DC bus line are able to be individually supplied centrally by means of a direct current network.

In one embodiment, the power supply source therefore has a boost converter having a direct voltage output, by means of which a specified high voltage for the central supply line is able to be provided in the IT network.

The boost converter, also referred to as a step-up converter or boost regulator, designates a form of DC/DC converter in the field of electronics. The amount of the output voltage is always greater than the amount of the input voltage. This allows for the direct voltage level at the direct voltage output to be flexibly adapted to the specified high voltage of the central DC supply line. The use of a step-up converter may be advantageous, in particular when combined with a PV generator as a power supply source, wherein the PV direct voltage is boosted such that the specified high voltage for being fed into the central supply line is provided at the direct voltage output.

In one embodiment, the boost converter is designed as a variable boost converter having a direct voltage output via which a specified high voltage is able to be provided in the IT network on the central supply line with an output voltage of above 1.5 kV, particularly of above 10 kV.

In one embodiment, the variable boost converter is designed such that a direct voltage with a high-voltage level of 10 kV to 110 kV, preferably of 30 kV to 60 kV, is able to be provided.

In one embodiment of the electrolysis system, the power supply source has, as a power generator, a wind turbine to which a rectifier having a direct voltage output is connected, the direct voltage output being designed for the high voltage in the central DC high-performance strand.

In this way, by means of the central DC supply line designed as an IT network, a coupling or direct current connection and supply of the electrolysis plant by a wind turbine or photovoltaic plant is achieved in the electrolysis system, wherein it is particularly advantageous that reliable microgrid operation is achieved. If operated in a microgrid, the electrolysis system is not coupled to the public power grid. Thus, the network frequency of the public power grid of 50 Hz to 60 Hz is insignificant for the design and operation of the electrical components in the DC-powered IT network. In particular, there are no costs for components and conversion losses, for example transformers, or for the required inversion, transmission or re-rectification. This may result in reduced costs in the future while maintaining flexibility in operation and, for example, when designing and selecting the connecting components in the DC network. An operation independent of the mains frequency is achieved by means of the central supply line designed as a DC bus, which is part of the insulated DC high-performance strand. Depending on the design of the DC high-performance strand as an IT network, the direct voltage output of the rectifier may already provide the high voltage directly. However, it is also possible for a variable boost converter to be connected downstream of the rectifier, the direct voltage output of which may deliver a specified high voltage on the DC high-performance strand.

Thus, with the insulated DC network, it is advantageously possible to overcome larger distances and line lengths between the power generators and the electrolysis plants in an inexpensive manner as needed without requiring another AC conversion for boost and downward transformations to be performed, which would only be able to be accomplished by means of multiple and costly transformers. However, smaller distances and compact electrolysis systems are more advantageous in an IT network in terms of ensuring better symmetry of the network poles and lower voltages due to the smaller spatial distances of the protective grounding of the housings of the equipment, such as the tower of the wind turbine and the process engineering unit of the electrolysis plant. In particular, all conductive components that are not part of the operating circuit are grounded either individually or collectively, or the components may be collectively connected to the protective ground of the system. If the network has a small spatial extent, the leakage currents in the event of a fault are so small that they are harmless, which is why a smaller spatial extent and compact installation of the DC high-performance strand are generally preferable.

In one embodiment, in the electrolysis system, an electrolysis plant is arranged at the base of the tower of a wind turbine and directly connected to the central supply line for direct current as equipment in the IT network. In particular for possibly remote onshore wind turbines, it is advantageous for an electrolysis plant in the electrolysis system to be connected to the central insulated DC bus line of the insulated DC high-performance strand near the wind turbine. Then, if DC/DC converters are preferably employed, the supply line is designed and charged with high direct voltage such that usage of materials, such as copper and aluminum, in particular, is reduced and the manufacturing costs are lowered correspondingly.

In one embodiment, the electrolysis plant in the electrolysis system has a number of electrolysis modules connected in series such that a row of modules is formed.

As such, in one embodiment, each of the electrolysis modules may be both physically and functionally a structural unit in which a plurality of electrolysis cells are stacked. With the modular concept of the electrolysis plant, a row of modules is readily expandable into an electrolysis stack comprising multiple modules, for example 5 to 10 modules for one row of modules.

In one embodiment, in a row of modules, a connectable, electrically conductive ground connection is provided with a specified ground resistance by means of which a control of stray currents is able to be performed.

This provides protective grounding at the housing, which is attached to the housing of a module, for example on the last module in a row of modules facing away from the electrical connection to the central insulated DC supply line. The protective grounding may also be designed as a grounded structure on the housing of the power supply source, for example on the tower of a wind turbine. Thus, optionally, two-point protective grounding is also implemented in the electrolysis system, which is advantageous in conjunction with the insulation monitor. In addition, the connectable, electrically conductive ground connection allows discharge to be carried out in a simple manner, for example for maintenance purposes of the insulated network, in particular of the DC high-performance strand.

Thus, residual stray currents and ground loops are avoided. Preferably, the protective ground line is provided at the last module in a row of modules, with a defined resistance being adjustable for the ground connection. This is useful for adjusting and minimizing harmful stray currents produced at the process engineering unit. However, the respective tap of the protective ground line at a module of a row of modules may be flexibly adaptable depending on the direct voltage with regard to the direct voltage and its polarity at the direct voltage output.

If, for example, a direct voltage of +250 V and −250 V is output on both poles as the direct voltage output of a rectifier used, grounding is advantageously accomplished via the protective ground line in the middle of the electrolysis row, where the voltage is at almost 0 V anyway.

However, if a direct voltage of +500 V and 0 V is output on both poles as the direct voltage output of a rectifier used, for example, grounding is accomplished via the protective ground line preferably at the last module, as the voltage against ground will then be almost 0 V there.

A remaining stray current issue as a result of the hydraulic interconnection of the cell elements of a stack to supply fresh electrolyte is also addressed in combination with the IT network design of all equipment. By hydraulically interconnecting the cell elements to form a stack, additional and undesirable electrically conductive connections and stray currents are created between all of the cell elements, which may cause corrosion effects.

In one embodiment of the electrolysis system, it has at least two electrolysis plants which are connected in parallel to each other relative to the central supply line, wherein an electrolysis plant is connected to the central supply line by means of a respective connecting line.

Thus, the insulated DC network is readily expandable, wherein further electrolysis plants may be connected to the central DC supply line and supplied thereby. As such, it is also optionally possible for two or more central supply lines to be present in the electrolysis system, depending on the required transmission power of the DC high-performance strand, to which a respective electrolysis plant with a respective row of modules is connected. All rows of modules are then optionally grounded with a, in particular common, protective ground. As such, an electrolysis plant has at least one row of modules, for example, two rows of modules may be connected in parallel in an electrolysis plant. However, it is also possible for an electrolysis plant to have only one row of modules, with a plurality of electrolysis modules electrically connected in series.

In the electrolysis system, the electrolysis plants are connected in parallel to each other relative to the central supply line, wherein an electrolysis plant is connected to the central supply line by means of a respective connecting line.

This shows the advantages of the DC bus principle having the central and insulated direct current supply line, which allows for a respective independent connecting line for an electrolysis plant and actually provides the same. In the electrolysis system, the central DC supply network may be able to be developed flexibly as needed and be expandable by further electrolysis plants, possibly by adapting the feed power of the power supply sources feeding into the insulated DC network with regard to an output power to be provided for operation of the electrolyzers.

In one embodiment of the electrolysis system, the power supply source has, as a power generator, a photovoltaic plant, the direct voltage output if which is designed for the high voltage, wherein the direct voltage output is connected to the central supply line.

This allows for the direct voltage level at the direct voltage output to be flexibly adapted to the specified high voltage of the central DC supply line. If needed, boost converters, so-called step-up converters, are connected downstream of the PV generator for adjusting the specified direct voltage level at the direct voltage output. This will be required if the DC output of the photovoltaic plant itself does not provide a sufficiently high DC voltage level to be fed into the central supply line.

This embodiment achieves one coupling or connection and supply of the electrolysis plant in the electrolysis system via the central and insulated DC network on the supply line with power obtained from a photovoltaic plant. As such, microgrid operation based on photovoltaics is possible, wherein corrosion effects due to stray currents in the IT system are avoided or reduced. Analogously and corresponding to the advantages similar to the connection of the electrolysis plant to a wind turbine, as described above, the operation in a microgrid is independent from the public grid frequency, which particularly allows for high design flexibility and autonomous applications remote from the public power grid. Thus, the grid frequency of the public power grid of 50 Hz to 60 Hz is insignificant for the design and operation of the electrical components within the DC network. Here, at most, a step-up converter (DC/DC converter) is required for providing an increase in voltage of the PV generator as needed to cause direct current to be fed precisely at the specified high voltage into the central supply line. If needed, in the case of a wind turbine as the power supply source, a step-up converter may also be employed downstream of the rectifier to optionally set a higher voltage level at the central supply line than the one delivered by the rectifier at the direct voltage output.

In one embodiment, in the electrolysis system, the power supply source has, as a power generator, a hydraulic power plant having a generator, wherein a rectifier with a direct voltage output is connected to the generator. Then, in this embodiment as well, all operating components from the generator of the hydraulic power plant to the electrolysis plant are not grounded, i.e., are provided as ungrounded components of the IT network. In particular, the generator of the hydraulic power plant is not grounded.

Hence, it is possible and advantageous to employ a generator in a hydraulic power plant, which already outputs a frequency higher than the grid frequency directly at the generator output. Thus, the generator of the hydraulic power plant may be advantageously designed for the frequency of the alternating voltage input of the rectifier. Conversely, it is possible to flexibly adapt and select the rectifier depending on the respective output frequency of the generator of the hydraulic power plant. This low complexity and number of components may result in additional cost benefits when coupled to a hydraulic power plant, wherein microgrid operation of the electrolysis system is also possible here. Using the pole number and rotational speed, the output speed, and thus the alternating current frequency of the generator, may be calculated. Hence, generators in particular for hydraulic power plants are available for a higher-frequency alternating current output, such that a corresponding rectifier having an input designed for a higher frequency is applied in the electrolysis system. Very advantageously, this allows for off-grid operation, i.e., without needing to account for the grid frequency of the public power grid. Frequency-adapted coupling, for example by means of expensive and large transformers, is not required in the central DC network or may be omitted. In order to save line lengths, the electrolysis plant is arranged in the immediate vicinity of the generator and the direct current output of the rectifier of the hydraulic power plant and integrated therewith in the IT network via the DC high-performance strand, i.e., the equipment is installed ungrounded and is operated in isolation.

A further aspect of the invention relates to a use of an insulated DC network in the electrolysis system described, in which an electrolysis plant is connected to a central supply line for direct current such that a central DC high-performance strand is provided which is designed for the direct voltage and insulated from ground, wherein electrolysis direct current is fed into the electrolysis plant.

Therefore, the use is such that, starting from the generator of the power supply source, the entire DC high-performance strand up to the electrolysis plant is operated with the electrolyzers including the modules and the process engineering in one and the same IT network.

In one embodiment, an output voltage of above 1.5 kV, in particular of above 10 kV, is provided on the central supply line at the direct voltage output.

In one embodiment, in use, a high voltage of 10 kV to 110 kV, preferably of 30 kV to 60 kV, is provided on the central supply line at the direct voltage output.

Advantages and advantageous embodiments of the electrolysis system of the invention are to be considered as advantages and advantageous embodiments of the corresponding use and vice versa.

Further advantages, features and details of the invention will be apparent from the following description of preferred embodiment as well as from the drawing. The features and combinations of features mentioned in the description above, as well as the features and combinations of features mentioned in the following description of figures and/or shown only in the individual figures can be used not only in the respective indicated combination, but also in other combinations or individually without departing from the scope of the invention.

### BRIEF DESCRIPTION OF HE DRAWINGS

Exemplary embodiments of the invention are explained in detail with reference to a drawing. In the figures, in a schematic and highly simplified manner:

FIG. 1 shows an electrolysis system designed for microgrid operation, having an electrolysis plant and a wind turbine; and

FIG. 2 shows an electrolysis system designed for microgrid operation, having multiple rows of modules.

In the figures, like reference numerals have like meaning.

### DETAILED DESCRIPTION

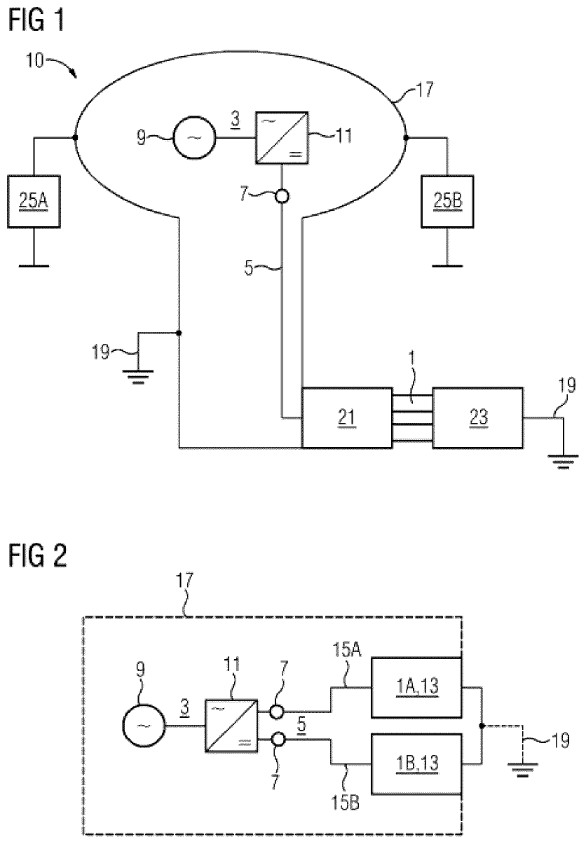

FIG. 1 shows an electrolysis system 10 according to the invention. Electrolysis system 10 comprises an electrolysis plant 1 and a power supply source 3. Power supply source 3 has, as a power generator, a wind turbine 9 functioning as a renewable energy (RE) plant and a source for green power. In electrolysis system 10, power supply source 3 is connected to electrolysis plant 1 via a central supply line 5. In a simplified representation, electrolysis plant 1 functionally comprises an electrolysis unit 21 having a plurality of electrolysis cells—not shown in detail in FIG. 1—stacked in the axial direction and electrically connected in series, as well as a process engineering unit 23. In electrolysis unit 21, the actual conversion reaction, i.e., the electro-chemical decomposition of water as a reactant to form hydrogen and oxygen as products, takes place in the electrolysis cells. Process engineering unit 23 is used for the hydraulic interconnection of the cell elements of a stack for delivering fresh electrolytes, here the water reactant. In contrast to the electrical interconnection, the hydraulic interconnection is established as a parallel connection. Hence, by hydraulically interconnecting the cell elements to form a stack, additional and undesirable electrically conductive connections are created between all of the cell elements. During operation of the stack of cell elements, i.e., application of an electric voltage or impressing of an electric current from the first to the last cell element, an electric working current flows through all of the cell elements.

Electrolysis system 10 is supplied with electrolysis direct current directly via a central supply line 5, to which a high direct voltage is applied, central supply line 5 thus forming a central DC bus line by means of which direct current for the electrolysis process is able to be supplied in electrolysis system 10 of electrolysis plant 1.

On the power supply source 3 side, a rectifier 11 having a direct voltage output 7 is connected downward of wind turbine 9 on the output side of a generator. Thus, an alternating current generated by the generator of wind turbine 9 may be fed into a direct current at a specified high voltage at direct voltage output 7 into central supply line 5. In this way, a central DC network is implemented which is designed for a high voltage. For coupling the power generated by wind turbine 9 and fed into rectifier 11, no further active components, such as transformers, are required when connecting wind turbine 9 to central supply line 5, such that a particularly simple supply topology is implemented for the electrolysis.

The connection topology illustrated in FIG. 1 provides a central DC high-performance strand in electrolysis system 10, which is configured as a component of a network 17 insulated from ground, a so-called IT network (“isolé terre”). As such, the entire DC high-performance strand is ungrounded. Any and all equipment, i.e., power supply source 3, here the generator of wind turbine 9, rectifier 11, central DC supply line 5, up to electrolysis plant 1, comprising electrolysis unit 21 and process engineering unit 23, are insulated from ground via a high insulation resistance and are components of IT network 17. During operation of electrolysis system 10, it is operated electrically insulated from ground. A protective ground 19 is attached to those conductive housing parts which are not part of the equipment. For example, as a grounded structure, the tower of wind turbine 9 may be designed with a protective ground 19. Similarly, on the electrolysis plant 1 side, a protective ground 19 is provided which is attached to the housing of process engineering unit 23 and connected to ground as a ground wire.

As a result, an electrically conductive ground connection is created nowhere in electrolysis system 10—if anything and if required, at best locally in the electrolysis plant itself for controlling the remaining residual stray currents. This ground connection is connectable or controllable as needed. The ungrounded supply topology avoids ground loops, and the stray current against ground is considerably reduced throughout the plant.

For monitoring the high insulation resistance of electrolysis system 10 against ground, insulated network 17 is provided with an insulation monitor 25A arranged near wind turbine 9. Another insulation monitor 25B is placed in the vicinity of electrolysis plant 1. This arrangement of insulation monitors 25A, 25B implements two spatially separated network poles which serve as measuring points. In this way, insulation monitors 25A, 25B detect possible ground faults, asymmetries and insufficient insulation resistances of insulated network 17. For this purpose, insulation monitor 25A, 25B measures the symmetry of the voltages of both network poles against ground. If the leakage currents of the two network poles are the same, symmetry is maintained. In order to be able to also detect symmetrical insulation faults, a test signal—in the simple case, a direct voltage—may be fed into the network asymmetrically via insulation monitors 25A, 25B and the reaction of network 17 may be measured. Thus, a minimum insulation resistance of insulated network 17 is monitored, an insulation fault is detectable and a ground fault is localizable. Simultaneously, symmetrical and high-resistance grounding may be implemented via the two network poles of the pair of insulation monitors 25A, 25B.

By eliminating the galvanic decoupling in insulated network 17, especially for supplying central supply line 5 with direct current, a more compact, easier to implement and very cost-effective supply topology is created, with high protection with regard to stray currents and associated adverse corrosion effects. In this case, the DC high-performance strand in insulated network 17 is at an electrically undefined potential against ground with all conductors of the equipment. For the reliable design as insulated network 17, the use of insulation monitors 25A, 25B is intended as a protective element. In the event of a simple ground fault, electrolysis system 10 may continue to be operated since there is no immediate danger to electrolysis plant 1, which increases availability. IT network 17 is single-fault tolerant.

The direct voltage level at direct voltage output 7 of rectifier 11 is flexibly adaptable to the respective requirement in electrolysis system 10, wherein a high output voltage is selected as a specified high voltage which is preferably greater than 1.5 kV. Here, when configuring and designing central and insulated DC network 17 by means of central supply line 5, the nominal voltages of the grid levels common in energy transmission may be adopted, for example, or these values may serve as a reference for the direct voltage level. In this respect, electrical energy is transmitted through high-voltage lines on different network levels of medium voltage and high voltage at the following common nominal voltages: medium voltage of 3 kV, 6 kV, 10 kV, 15 kV, 20 kV, 30 kV; high voltage of 60 kV, 110 kV. As such, very advantageously, central supply line 5 functions as a central DC bus line, which allows for directly supplying an electrolysis system 10 with high-voltage-based direct current.

For a particularly compact, i.e., spatially restricted, design and for correspondingly small line spacings in insulated network 17, electrolysis plant 1 may be arranged in electrolysis system 10 at the base of the tower of wind turbine 9 and, as equipment in IT network 17, be directly connected to central supply line 5 for direct current.

In a further highly simplified exemplary embodiment of an electrolysis system 10 according to the invention, FIG. 2 shows an alternative interconnection of the DC high-performance strand to a central supply line 5. In turn, as a power supply source 3 for providing direct current for electrolysis, a wind turbine 9 is shown, which has a generator with an alternating current output. The alternating current is converted into direct current in rectifier 11.

On the electrolysis system 10 side, a plant concept which is basically similar to that in FIG. 1 is applied and corresponding plant components are provided, with all equipment being installed and electrically connected in an insulated network 17 which can be operated with direct current and comprises the DC high-performance strand. Here, the electrical coupling and supply of electrolysis plants 1A, 1B is via respective connecting lines 15A, 15B. As a pair of lines, connecting lines 15A, 15B form the central DC bus line or the DC high-performance strand of central supply line 5. To achieve this, an electrolysis plant 1A is connected to a direct voltage output 7 and, accordingly, a further electrolysis plant 1B is connected to a further direct voltage output 7 of rectifier 11 via connecting line 15B in parallel to connecting line 15A. Electrolysis plants 1A, 1B each have a row of modules 13, comprising a number of electrolysis modules electrically connected in series. Each of the modules in a row of modules 13 has a plurality of electrolysis cells electrically connected in series.

A connectable ground connection 19 is provided locally as protective grounding on housing parts of equipment of electrolysis plant 1A, 1B. The equipment itself is at a potential against ground. The local ground connection of the housing parts is attached to the last module of respective row of modules 13 as a conductive connection. Conductive ground connection 19 has a specified low ground resistance which allows control and discharge of stray currents to be able to be performed and optimized. To this end, conductive ground connection 19 may have variable resistance. This additional measure means that corrosion caused by any stray currents that may still be present can be avoided or further reduced via the advantageous microgrid operation.

Alternatively, it is also possible that, depending on the voltage value and polarity at both direct voltage outputs 7 of rectifier 11, conductive ground connection 19 is established at a module within row of modules 13. This is flexibly adaptable to the respective direct voltage levels at direct voltage output 7 and the electrical configuration design of the plant concept of electrolysis system 10. Depending on the topology, grounding can therefore also just be accomplished in the middle of a row of modules 13. For example, in the event that rectifier 11 outputs a symmetrical voltage at direct voltage output 7, i.e., values of +/−250 V at direct voltage output 7, for example, this would have to be provided accordingly and would be advantageous. This ground connection 19 may also be designed as a fixed connection, i.e., it does not necessarily have to be connectable, but may also simply be a fixed ground connection 19.

If needed, it is possible for a buck converter—not shown in detail in FIG. 1 and FIG. 2—to be connected in a connecting line 15A, 15B for adapting the voltage level, the input voltage of which corresponds to the DC high voltage in the central DC network and the output voltage of which is designed for a respective operating voltage of electrolysis plant 1A, 1B. This enables an adapted operating style of electrolysis system 10 and establishes an individual direct voltage supply of a respective electrolysis plant 1A, 1B. Employing possibly multiple high-current DC/DC converters connected in parallel in a connecting line 15A, 15B and having a modular design is particularly advantageous.

This allows for industrial application and integration with an electrolysis system 10. The buck converter converts an input voltage to a lower output voltage. It is also referred to as a step-down converter.

On one or more such central DC branch strands in insulated DC network 17 or connecting lines 15A, 15B, any number of electrolysis plants 1A, 1B of any size having customizable rows of modules 13 may advantageously be connected using variable DC/DC converters, in particular so-called variable step-down converters or buck converters, and operated in a microgrid designed as an insulated DC network 17.

The DC/DC converters individually lower the DC voltage to the desired values without significant conversion losses. Thus, in electrolysis system 10, electrolysis plants 1A, 1B are both variable with respect to electrolysis power and able to be enabled or disabled as needed. A partial load capability or partial load control is achieved by regulating the electrolysis current. By coordinating the power controllers, the microgrid capability in the insulated DC network is ensured and expanded, which brings significant cost advantages for remote onshore plants or even offshore plants. In order to provide higher electrolysis currents, if needed, multiple DC/DC converters may be connected in parallel and employed in a connecting line 15A, 15B. Preferably, the buck converter is a controllable buck converter controlling the output voltage using a pulse width modulation method in continuous operation. In this way, continuous operation of the step-down converter is achieved and the electrolysis current supplied to each electrolysis plant 1A, 1B may be varied.

In electrolysis system 10, it is also possible for power supply source 3 to have a photovoltaic plant, having a plurality of PV modules not shown in detail. For example, the photovoltaic plant may be designed as a large-area and high-performance ground-mounted plant—preferably in regions with a lot of sunshine—such that PV outputs of 10 MW of electrical power and more are available for electrolysis. Other types of power generation from renewable sources are also possible.

The central DC high-performance strand of insulated network 17 mostly eliminates the employment of transformers compared to a supply based on alternating current. The usage of material and installation space due to the weight and size of required transformers in case of an AC grid coupling may be significantly reduced as a result of configuring and defining a central high-voltage direct current supply network. This reduces material usage, particularly regarding iron and copper, which in turn requires less installation space.

With electrolysis system 10 of the invention, an electrical connection or the electrical coupling of preferably onshore wind turbines to electrolysis plants in an insulated DC network 17, which is generally set up in a spatially restricted manner, is achieved in a particularly advantageous and cost-effective way. This means that possible voltage differences across the network poles are a priori smaller. Insulation monitors 25A, 25B also provide precautions for secure IT network operation, particularly with regard to 2nd-order faults, i.e., to also be able to detect symmetrical insulation faults at both network poles. This is why a possible first ground fault is harmless in IT network 17 because the currents caused only by line capacities and insulation resistances of the equipment of electrolysis system 10 are small. If the spatial extent of the network 17 is small, the leakage currents in the event of a fault are so small that they are harmless as well.

1. An electrolysis system comprising an electrolysis plant and a power supply source with a direct voltage output and comprising a central supply line, wherein the central supply line is connected to the direct voltage output of the power supply source such that a direct current can be fed to the central supply line, wherein a central DC high-performance strand designed for the direct voltage is provided, to which high-performance strand the electrolysis plant is connected via the central supply line, wherein the power supply source and the DC high-performance strand are designed as components of a network insulated from ground.

2. The electrolysis system according to claim 1, in which an insulation monitor is provided such that a minimum insulation resistance of the insulated network from ground is able to be monitored and an insulation fault is detectable.

3. The electrolysis system according to claim 1, in which the power supply source has, as a power generator, a wind turbine to which a rectifier having a direct voltage output is connected, the direct voltage output being designed for a high voltage in the central DC high-performance strand.

4. The electrolysis system according to claim 3, having an electrolysis plant which is arranged at a base of a tower of the wind turbine and is connected there directly to the central supply line.

5. The electrolysis system according to claim 4, in which the electrolysis plant has a number of electrolysis modules connected in series such that a row of modules is formed.

6. The electrolysis system according to claim 5, in which, in a row of modules, a connectable, electrically conductive ground connection is provided with a specified ground resistance by means of which a control of stray currents is able to be performed.

7. The electrolysis system according to claim 5, in which, in a row of modules, a permanently installed electrically conductive ground connection is provided with a specified ground resistance by means of which a control of stray currents is able to be performed.

8. The electrolysis system according to claim 5, comprising at least two electrolysis plants connected in parallel to each other relative to the central supply line, wherein an electrolysis plant is connected to the central supply line via a respective connecting.

9. The electrolysis system according to claim 5, in which the power supply source has, as a power generator, a photovoltaic plant having a direct voltage output, wherein the direct voltage output is designed for the high voltage, and wherein the direct voltage output is connected to the central supply line.

10. The electrolysis system according to claim 5, in which the power supply source has, as a power generator, a hydraulic power plant having a generator, wherein a rectifier having a direct voltage output is connected to the generator.

11. A use of an insulated DC network in an electrolysis system according to claim 1, in which an electrolysis plant is connected to a central supply line for direct current such that an insulated DC high-voltage strand is provided which is designed for the direct voltage, wherein electrolysis direct current is fed into an electrolysis plant.
